(19) United States
(12) Patent Application Publication
(10) Pub. No.: US 2005/0220983 A1
(43) Pub. Date: Oct. 6, 2005

(54) Method of processing a stack of coatings and apparatus for processing a stack of coatings

(76) Inventor: Jonathan Hayes, Loughborough (GB)

Correspondence Address: 3D SYSTEMS, INC., 26081 AVENUE HALL, VALENCIA, CA, 91355, US

(21) Appl. No.: 10/514,597

(22) PCT Filed: Mar. 24, 2003
(86) PCT No.: PCT/GB03/01243

§ 371 Date: Nov. 15, 2004

(30) Foreign Application Priority Data
May 13, 2002 (GB) 0210780.3

(51) Int. Cl. B05D 1/00; B05D 3/02; B32B 31/00

(52) U.S. Cl. 427/8; 427/374.1; 156/64; 156/155; 156/264; 156/353

(57) ABSTRACT

A method for making a part using the following steps using data derived from a slicing programme to control a manufacturing means that makes coatings that are the cross sectional slices of the required part; organising the coatings, sheets and conductive plates so that they form a stack made of consecutive arrangements of plate, sheet and coating; heating the stack so that the coatings are processed; cooling the stack; and, removing coatings from the stack. If necessary the heat taken away during the cooling of a stack may be recycled, and the recycling may involve the use of a heat pump and/or a heat transfer device. The recycled heat may be used to increase the amount of power that can be used in processing stacks.

The invention relates to a method of manufacturing an item and an apparatus for manufacturing an item.

Known methods of manufacturing include injection moulding and die-casting. The manufacture of tooling for injection moulding or die-casting is a highly restrictive burden on industry, because of it's high cost and lead times. Similar things are true of the cost of tooling for punch pressing, while the time taken by processes such as photo-chemical machining, electro and electroless plating and the environmental issues that surround these processes limit their use. The cost and the time taken to post-assemble products substantially reduces the flexibility and competitiveness of manufacturing.

So-called “Solid Free Form manufacture” (SFF) systems have been used in Rapid Prototyping (RP) applications starting in 1988 with 3D Systems's introduction of their Stereolithography systems. The growth in the RP market has stimulated an accelerating rate of technological development in the field, and firms have developed different types of commercial systems for specific RP applications.

Solid Free Form (SFF) manufacture is essentially the computer-controlled additive manufacture of three-dimensional physical forms. All of the commercial SFF systems employ the same basic principle. CAD data of the desired component is sliced into a number of horizontal layers. Each of these layers is built in turn on top of the preceding layer, by the precise addition of material, until the object has been completed. SFF manufacture also encompasses the computer-controlled manufacture of objects comprised of a single layer plus any other additive method of manufacture.

All of the commercial systems use direct computer control of their additive manufacturing processes. Consequently, the main advantage that these systems have over machining and moulding processes is that they can produce a one-off object with complex geometry far more flexibly and quickly than machining and moulding can. The main problem with all of these systems is that they cannot manufacture large batches of duplicate objects as fast as machining and moulding can. These systems have extremely limited capabilities for producing SFF objects with surface or internal colour, tone or doping. Furthermore, none of them can produce objects with parts made of entirely different materials.

Stereolithography RP systems work by using an TV laser to selectively expose the surface of liquid Ultra Violet (UV) reactive polymer to UV radiation (typically from a laser source). This causes the polymer to cure into a solid in the exposed area. The polymer that has been solidified is a physical realisation of a slice of a CAD model. The solidified material is supported on a platform. A new flat area of liquid UV reactive polymer is then laid over this layer by lowering of the platform into the liquid, and the exposure process is repeated to form another layer that bonds to the previous one. This process is repeated until the entire part has been completed.

Another UV polymer curing system is Cubital Ltd's Solid Ground Curing (SGC) RP system. Here a thin layer of UV reactive polymer resin is spread over a platform and then exposed to UV radiation shone through a patterned mask. The transparent areas of the mask correspond to the required cross sections of a CAD model, and the UV radiation that passes through these areas cures part of the polymer layer into the pattern of the required cross section. Ionographic technology is used to produce the masks that represent the required cross sections, and once a mask has been used it is erased and then re-imaged and inked with a new mask. A residual polymer cleaner removes the uncured polymer and then a spreader coats the cured polymer in wax. A cooling plate is used to accelerate the solidification of the wax, and once this has solidified it is milled flat by a milling head. The above processes are repeated until the entire model has been built. The wax is removed from the finished products by melting it away with hot (60° C.) water.

By their nature, all of the commercial polymer-curing systems are limited to manufacturing objects out of UV reactive polymer. Consequently, the physical properties of these objects are not suitable for many functional applications.

Selective sintering systems have enabled objects to be made out of a wide range of powdered materials. As an example, one selective sintering method works by spreading a heat fusible powder on top of a movable platform that can be lowered within a cylinder that defines the maximum part volume. The layer of powder is then selectively fused by a laser that defines the layer of the CAD model. The platform is lowered and a new layer of powder is deposited and subsequently selectively fused to the preceding layer. This process is repeated until the object is completed.

By combining materials and coating the powders with various binders, it is possible to make specialised powders, tailored to particular functional applications.

Another rapid prototyping technique is “laminated object manufacture” (LOM). In this technique objects are built by sticking sheets of material together. An uncut sheet is laid down and a heated roller is passed over it which causes a coating of heat sensitive glue on the sheet to adhere it to the underlying sheet. A laser is then used to cut the sheet to the desired shape. Another layer is then added to the stack and the process is repeated. Most of the LOM RP systems are limited to manufacturing objects out of paper and polymers. Consequently, the physical properties of these objects are not suitable for many functional applications.

The “Fused Deposit Modelling” (FDM) process uses low diameter thermo polymer wire-like filaments, which are extruded in a hot semi-molten form from a delivery head. The motion of the delivery head is computer-controlled This allows the filament to be extruded in a pattern that produces a layer of the required object and the object is built up in a layer-wise fashion out of the extruded layers that bond together when they cool. The cost of converting the thermo polymer to a filament can be extremely high and so objects that contain a large volume of the extruded filament can be extremely costly in comparison to injection moulded objects.

The use of hot melt thermal jet printing, bubble jet printing, and drop on demand jet printing technology in rapid prototyping is quite a new-development The principle is relatively straightforward. Solid ink is loaded into an ink reservoir and then heated so that the molten ink runs off and is channelled into a piezo-electric jet printer head. The printer then ejects the ink in molten droplet form onto a substrate upon which the droplets cool and thus solidify and adhere. Some systems, such as Sanders Prototyping's Model Maker II use continuous-flow jet printers; others such as 3D Systems Actua 2100 use drop-on-demand (DOD) impulse jet printers. At present, these systems are limited to manufacturing objects out of waxes and thermo polymers. Consequently, the physical properties of these objects are not suitable for many functional applications.

MITs 3DP system, Soligen Inc's DSPC and Extrude Hone Corp.'s Prometal licensed versions use a different method from the previously mentioned selective sintering, but objects are still built by putting down a layer of powder. The difference is that the powder layers are bound together using a jet printer to deposit a binder or solvent selectively onto the powder. The process is repeated until the required three dimensional object is constructed. Finally the object is removed from the loose powder and any unbound powder left on the object or trapped in inclusions is cleaned away.

Topographic Shell Fabrication (TSF) is a proprietary RP technology developed by Formus, USA. The TSF system is designed for manufacturing ultra large objects that can be the size of cars or even larger. The TSF system comprise a chamber, a layering device that deposits consecutive horizontal layers of silica powder into the chamber and a nozzle that selectively infiltrates a paraffin wax binder into the powder.

Objectives of the invention are as follows:
The processing of coatings made of a broad range of medical, pharmaceutical, engineering and/or electronic materials.
A cost-effective alternative to processes such as solder reflowing, selective laser sintering, selective UV curing, selective thermoset curing, thermographic emitter section melting, batch oven processing, microwave heating, induction heating, RF heating, pressing, laminating, compression moulding, photo-chemical machining, electroless forming, electro forming or punch pressing.
Processing capable of competing with mass-production rates of solder reflowing, selective laser sintering or melting, selective LW curing, selective thermoset curing, thermographic emitter section melting, batch oven processing, microwave heating, induction heating, RF heating, pressing, laminating, compression moulding, photo-chemical machining, electroless forming, electro forming or punch pressing.

According to the invention there is provided a method of manufacturing an item using the following steps:
Making coatings.
Collating coatings, sheets and conductive plates so that they form a stack made of consecutive arrangements of plate, sheet and coating.
Heating the stack so that the coatings are processed.
Cooling the stack and, if required, recycling the heat.
Removing coatings from the stack.

In this way, coatings can be processed rapidly, using equipment that is readily available and inexpensive.

According to another aspect of the invention, there is provided apparatus for processing coatings including:
Means of making coatings.
Means for collating coatings, sheets and conductive plates that form a stack made of consecutive arrangements of plate, sheet and coating.
Means for heating the stack so that the coatings are processed
Means for cooling the stack and, if required, means for recycling the beat
Means for removing coatings from the stack.

A specific embodiment of the invention will now be described by way of example with reference to the accompanying drawings in which:

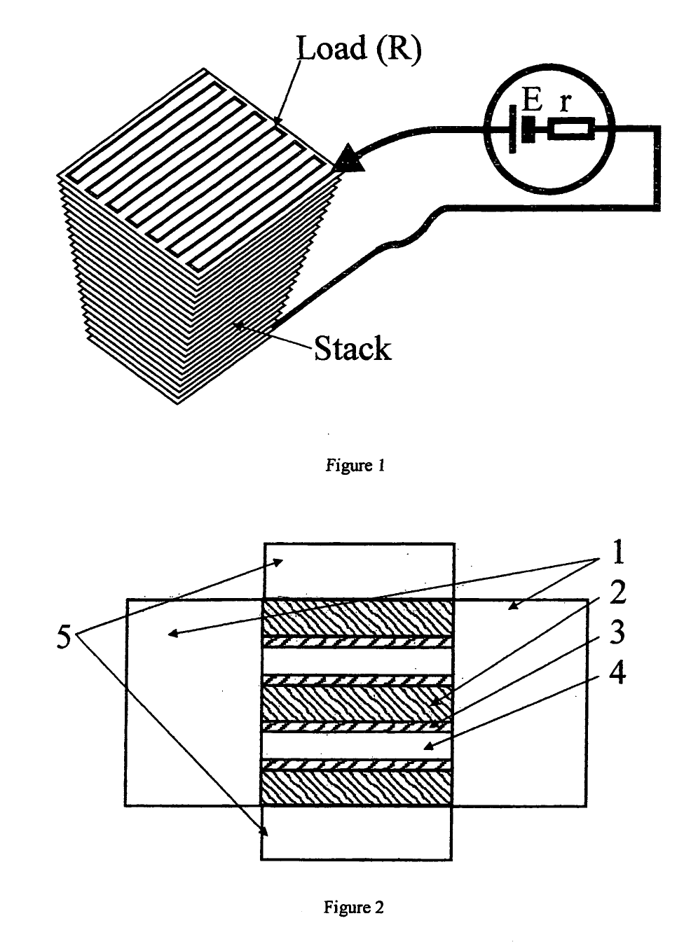

FIG. 1: Shows a way of using electrical resistance heating elements embedded in the substrates of a stack of coated substrates to raise the temperature of the stack to the melted temperature of the stack's coating material.

FIG. 2: Shows a coated substrate and hot plate arrangement that may allow a stack of coatings to be raised to the coating's melted temperature and compressed more rapidly than if it was heated without the use of hot plates.

The following means may be used to make coatings:
Pick and place component assembling;
Embroidering or sewing;
Printing that uses systems based on electrophotography, toner jet printing, magnetography, ionography, thermal transfer, thermal jet printing, bubble jet printing, drop on demand jet printing, hot melt or phase change thermal jet printing, elcography, continuous flow jet printing, lithographic printing; screen printing, flexography, gravure printing, metal press printing, hot foil stamping, thermography or tampography technology;
Laser cutting, die cutting, stamping, punch pressing, computer navigated knife cutting or label cutting;
Electroforming, etching, machining, selective UV or Thermal curing;
Extrusion or laminating,
Combinations of the previously mentioned means or other means may also be used to make the coatings.

It is preferable, though not essential, that a means for making coatings be controlled by a computer, so that it makes a coating that has the required geometry.

If necessary the data used by the computer to control the geometry may be derived from a CAD model or slicing programme.

The means for collating coatings, sheets and conductive plates that form a stack made of consecutive arrangements of plate; sheet and coating may be any form of collator used in industry.

If necessary joggers may be used with the collators to ensure the stack is formed with the required uniformity and registration.

The means for making coatings may require that they be made on sheets, and the sheets with coatings would then be collated with the plates. Alternatively, the means might make coatings on sheets that are, or are composites of, sheet and conductive plate. In this instance, the collation would be performed entirely or in part by the means for making the coatings.

If necessary joggers may be used with the means for making the coatings, to ensure that the stack is formed with the required uniformity and registration.

A collated stack with the required uniformity and registration is then heated so that the coatings are processed. This may involve melting, sintering or curing the coatings.

The means for causing the beating may involve the use of electrical heating elements that are part of the sheet (see FIG. 1), or conduction of heat by means of conductive plates (see FIG. 2). In the latter case, it is preferable that the edges of the stack be brought into contact with heating blocks (1) so that the edges of the plates (2) touch the blocks (1). This ensures that the heat will be efficiently and rapidly conducted into the stack. As previously stated the stack is made of sheets (3), plates (2) and coatings (4) and it is preferable, though not essential, that a device (5) apply pressure to the stack during the heating (see FIG. 2). This ensures the dimensional stability of the coatings.

The cooling of a stack may involve the use heat transfer and heat pumps, and this may be used to recycle beat to another stack to increase the amount of power that can be used in heating.

The cooling may also involve an annealing stage, to remove any tension that has been built up in a coating by the processing.

A cooled stack may then be separated and if necessary the coatings can be taken off the sheets. Alternatively, the coatings may be left on the sheets.

Processed coatings, or sheets with processed coating on them, may then be sent back to the means for making the coatings, and additional coating may be made on them.

If it is necessary, the method or apparatus described in the invention may be used to process additional coatings, so that they bond to the former coatings.

The conductive plates may be covered with a non-stick insulating material that faces the coatings and not the sheet. The conductive material of the plate may be graphite, aluminium, copper, stainless steel, nicrome, steel, tungsten, molybdenum, tantalum, carbon, gold, platinum, boron nitride, combinations of the previously mentioned materials or other conductive materials.

The sheet may be covered with or be PTFE, PVDF, PFA, PES, PPS, PEN, PEK, PEEK, PEL PI, PAI, FEP, boron nitride, polyvinyl alcohol, nylon, poly (2-ethyl-2-oxazoline), salt, polyethylene glycol, polyethylene oxide, wax, starch, sugar, magnesium oxide, magnesium hydoxide, calcium oxide, calcium hydroxide, sodium oxide, sodium hydroxide, sodium chloride, alumina, zirconium silicate, molochite, talc, carbon, gum Arabic, carboxy methyl cellulose, alginate, Agar, zanthum gum, albumin or it may be made of a plurality of the previously mentioned materials, to make it easier to process and/or remove coatings from them.

Dependent on the capabilities of the means used, coatings may be made of polyester, nylon, polyvinyl butyral, polyurethane, polystyrene, melimine, PVC, polypropylene, polyethylene, polysulphone, polyethersulphone, amino, silicone, silicon, styrenic rubber, olefinic rubber, PES, PPS, PEN, PEI, PL PAI, FEP, PFA, PA bisphenol A epichlorohydrin, bisophenol A epoxy, bisphenol epoxy ester or bisphenol A trimellitic epoxy ester, phenolic resin, acrylic, ABS, cellulose, polyimide, PTFE, Acetal, cellulose acetate, PEK, PEEK, PET, polycarbonate, polyvinyl alcohol, poly(2-ethyl-2-oxazoline), polyethylene glycol, wax, zinc, aluminium, stainless steel, steel, titanium, vanadium, tantalum, nickel, copper, bronze, brass, indium, tin, gold, silver, solder, magnesium, tungsten, tungsten carbide, silica, alumina, molochite zirconium silcate, carbon, combinations of the previously mentioned materials or other materials.

Removing involves the releasing coatings from sections that are not to be permanent If this is necessary, it is performed after the coatings have been processed If the sections are appropriately soluble, the releasing may involve dissolving them. Alternatively, manual means, peeling, shot blasting, catalysed or thermal degradation may be used to release a coating. The type of material that the sections are made of determines the type of material that may be used to dissolve or catalyse it as follows:
Water-soluble sections may be dissolved with water.
Polyester may be dissolved with hexafluoro-2-isopropanol, acetophenone, pyridine, quinoline, tetralin, xylene, 1,2-dichloroethane or 1-methylnaphalene.
Nylon coatings may be dissolved with aniline, benzyl alcohol, cyclohexanol, dibasic ester, ethylene glycol 2 ethylhexyl ether, 1-octanol or 1-methylnaphalene.
Polyvinyl butyral sections may be dissolved with aniline, benzyl alcohol, cyclohexanol morpholine or propylene glycol phenyl ether.
Polyurethane sections may be dissolved with acetic acid, acetone, amyl acetate, aniline, anisole (methyoxybenzene), benzyl alcohol, butylene glycol ethyl ether, butylene glycol n-butyl ether, diacetone alcohol, diasic ester, diethylene glycol butyl ether, diglyme, n-propylamine or 1,2-cyclohexane carbonate.
Polyethylene sections may be dissolved with hydrocarbons, halogenated hydrocarbons or hot toluene, xylene, amyl acetate, trichlorethylene, petroleum ether, paraffin, turpentine, aniline, anisole, cyclhexylamine, dibasic ester, diethyl carbonate, methylene chloride, quinoline, 1,1,2,2-tetrachlorethane or 1,4-diaxane.
Polystyrene sections may be dissolved with methylene chloride, MEK, benzene, toluene, ethyl benzene, chloroform, carbon disulfide, carbon tetrachloride, esters, ketones, ansole (methoxybenzene) or cyclohexanone.
Melimine sections may be dissolved with aniline or benzyl alcohol.
PVC sections may be dissolved with actone, acetophenone, aniline, ansole or ethylene glycol butyl ether acetate.
Polypropylene sections may be dissolved with benzene, carbon tetrachloride or decalin mesitylene.
Sections composed of or containing bisphenol A epichlorohydrin, bisophenol A epoxy, bisphenol epoxy ester or bisphenol A trimellitic epoxy ester sections may be dissolved with acetic acid, acetone, cylophexylamine, dibasic ester, diethylamine or diethylketone.
Phenolic resin sections may be dissolved with allyl alcohol, benzyl alcohol, cyclohexane, diethylenetriamine, ethylene glycol diacetate, furfuryl alcohol, 1,2-dimethyl imidazole or 2-pryrrolidinone.
If the sections are made of acrylic, and dependent on the particular acrylic used, sections may be dissolved with pyridine, quinoline, tetrahydrofurfuryl alcohol, amyl acetate, ansole (methoxybenzene), butylene glycol ethyl ether, butylenes glycol methyl ether, acetophine, aniline, chloroform, cumene (isopropylbenzene), diethyle phthalate, acetic acid, allyl alcohol, butylene glycol n-propyl ether, hexanol (2-methyl-1-pentanol), propylene glycol isopropyl ether, cyclohexylamine, tetralin, xylene, acetophenone, o-xylene, tetralin, mineral spirits, acetophenone, acetone, methylene chloride or halogenated hydrocarbon.
Cellulose sections may be catalysed with cellulase.
Starch sections may be catalysed with amylase.
Hydrogen peroxide sections may be catalysed with catalase.

The sections may be made of any of the material that the means for making the coatings uses. Consequently, a section may be made of polyester, nylon, polyvinyl butyral, polyurethane, polystyrene, melimine, PVC, polypropylene, bisphenol A epichlorohydrin, bisophenol A epoxy, bisphenol epoxy ester or bisphenol A trimellitic epoxy ester, Phenolic resin, acrylic, ABS, cellulose, polycarbonate, polyvinyl alcohol, poly(2-ethyl-2-oxazoline), polyethylene glycol, polyethylene oxide, wax, starch, sugar, magnesium oxide, magnesium hydroxide, calcium oxide, calcium hydroxide, sodium oxide, sodium hydroxide, sodium chloride, alumina, zirconium silicate, molochite, talc, carbon, gum Arabic, salt, carboxy methyl cellulose, alginate, Agar, zanthum gum or albumin, or it may be made of a plurality of the previously mentioned materials.

1. A method for making a part using the following steps:
using data derived from a slicing program to control a manufacturing means that makes coatings that are the cross sectional slices of the required part;
organizing the coatings, sheets and conductive plates so that they form a stack made of consecutive arrangements of plates, sheets and coatings;
heating the stack so that the coatings are processed;
cooling the stack; and,
removing coatings from the stack.

2. The method according to claim 1 further comprising recycling heat during the cooling of a stack.

3. The method according to claim 2 further comprising recycling by heat transfer.

4. The method according to claim 3 further comprising using a heat pump to recycle.

5. The method according to claim 2 further comprising using the recycled heat to increase the amount of powder that can be used in processing stacks.

6. The method according to claim 1 further comprising the cooling including an annealing stage to remove tension that has been built up in the coatings by the processing.

7. The method according to claim 1 further comprising separating a cooled stack so that the coatings are left on the sheets.

8. The method according to claim 7 further comprising applying additional coatings to the sheets.

9. The method according to claim 7 further comprising the steps of:
organizing new coatings with cooled coatings, sheets and conductive plate to form a stack made of consecutive arrangements of plate, sheet and coating;
heating the stack so that the new coatings are processed and bonded to prior processed and cooled coatings;
cooling the stack;
removing coatings from the stack.

10. The method according to claim 9 further comprising the conductive plates are selected from the group consisting of graphite, aluminum, copper, stainless steel, nicrome, steel, tungsten, molybdenum, tantalum, carbon, gold, platinum, boron nitride or combinations thereof.

11. The method according to claim 9 further comprising the sheet is being covered with a material selected from the group consisting of PTFE, PVDF, PFA, PES, PPS, PEN, PEK, PEEK, PEI, PI, PAI, FEP, boron nitride, polyvinyl alcohol, nylon, poly (2-ethyl-2-oxazoline), salt, polyethylene glycol, polyethylene oxide, wax, starch, sugar, magnesium oxide, magnesium hydroxide, calcium oxide, calcium hydroxide, sodium oxide, sodium hydroxide, sodium chloride, alumina, zirconium silicate, molochite, talc, carbon, gum Arabic, carboxy methyl cellulose, alginate, Agar, zanthum gum, albumin to make it easier to process and/or remove coatings from sheets.

12. The method according to claim 9 wherein the coatings are selected from the group consisting of polyester, nylon, polyvinyl butyral, polyurethane, polystyrene, melamine, PVC, polypropylene, polyethylene, polysulphone, polyethersulphone, amino, silicone, silicon, styrenic rubber, olefinic rubber, PES, PPS, PEN, PEI, PI, PAI, FEP, PFA, PA bisphenol A epichlorohydrin, bisophenol A epoxy, bisphenol epoxy ester or bisphenol A trimellitic epoxy ester, phenolic resin, acrylic, ABS, cellulose, polyimide, PTFE, Acetal, cellulose acetate, PEK, PPEK, PET, polycarbonate, polyvinyl alcohol, poly(2-ethyl-2-oxazoline), polyethylene glycol, wax, zinc, aluminum, stainless steel, steel, titanium, vanadium, tantalum, nickel, copper, bronze brass, indium, tin, gold silver, solder, magnesium, tungsten, tungsten carbide, silica, alumina, molochite zirconium silicate, carbon and combinations thereof.

13. The method according to claim 1 wherein the step of removing further includes releasing sections from the coatings that are not to be permanently coated.

14. The method according to claim 13 wherein the step of releasing further includes dissolving or catalizing away the sections from the coatings that are not to be permanently coated.

15. The method according to claim 13 wherein the step of releasing further includes manual, peeling, shot blasting or thermal degradation means for removing the sections from the coatings that are not to be permanently coated.

16. The method according to claim 14, wherein the sections further are made of polyester, nylon, polyvinyl butyral, polyurethane, polystyrene, melamine, PVC, polypropylene, bisphenol A epichlorohydrin, bisophenol A epoxy, bisphenol epoxy ester or bisphenol A trimellitic epoxy ester, Phenolic resin, acrylic, ABS, cellulose, polycarbonate, polyvinyl alcohol, poly(2-ethyl-2-oxazoline), polyethylene glycol, polyethylene oxide, wax, starch, sugar, magnesium oxide, magnesium hydroxide, calcium oxide, calcium hydroxide, sodium oxide, sodium hydroxide, sodium chloride, alumina, zirconium silicate, molochite, talc, carbon, gum Arabic, salt, carboxy methyl cellulose, alginate, Agar, zanthum gum, albumin and combinations thereof.

17. The method according to claim 16 wherein the sections that are soluble or catalyzable include water-soluble sections dissolved with water; polyester sections dissolved with hexafluoro-2-isopropanol, acetophenone, pyridine, quinoline, tetralin, xylene, 1,2-dichloroethane or 1-methylnaphaline; nylon sections dissolved with aniline, benzyl alcohol, cyclohexanol, dibasic ester, ethylene glycol 2 ethylhexyl ether, 1-octanol or 1-methylnaphalene; polyvinyl butyral section dissolved with anile, benzyl alcohol, cyclohexanol morpholine or propylene glycol phenyl ether; polyurethane sections dissolved with acetic acid, acetone, amyl acetate, aniline, anisole (methyoxybenzene), benzyl, alcohol, butylene glycol ethyl ether, butylenes glycol n-butyl ether, diacetone alcohol, diasci ester, diethylene glycol butyl ether, diglyme, n-propylamine or 1,2-cyclohexane carbonate; polyethylene section dissolved with hydrocarbons, halogenated hydrocarbons or hot toluene, xylene, amyl acetate trichloroethylene, petroleum ether, paraffin, turpentine, aniline, anisole, cyclhexylamine, dibasic ester diethyl carbonate, methylene chloride, quinoline, 1,1,2,2-tetrachlorethane or 1,4-diaxane; polystyrene sections dissolved with methylene chloride, MEK, benzene, toluene, ethyl benzene, chloroform, carbon disulfide, carbon tetrachloride, esters, ketones, ansole (methoxybenzene) or cyclohexanone; melamine sections dissolved with aniline or benzyl alcohol; PVC sections dissolved with acetone, acetophenone, aniline, ansole or ethylene glycol butyl ether acetate; polypropylene sections dissolved with benzene, carbon tetrachloride or decalin mesitylene; phenolic resin sections dissolved with allyl alcohol, benzyl alcohol, cyclohexane, diethylenetriamine, ethylene glycol diacetate, furfuryl alcohol, 1,2-dimethyl imidazole or 2-pryrrolidinone; acrylic sections dissolved with pyridine, quinoline, tetrahydrofurfuryl alcohol, amyl acetate, ansole (methoxybenzene), butylenes glycol ethyl ether, butylenes glycol methyl ether, acetophine, aniline, chloroform, cumene (isopropylbenzene), diethyle phthalate, acetic acid, allyl alcohol, butylene glycol n-propyl ether, hexanol (2-methyl-1-pentanol), propylene glycol isopropyl ether, cyclohexylamine, tetralin, xylene, acetophenone, o-xylene, tetralin, mineral spirits, acetophenone, acetone, methylene chloride or halogenated hydrocarbon; cellulose sections catalyzed away by cellulose; starch sections catalyzed away by amylase; hydrogen peroxide sections catalyzed away by catalase; and, sections composed of or containing bisphenol A epichlorohydrin, bisophenol A epoxy, bisphenol epoxy ester or bisphenol A trimellitic epoxy ester sections dissolved with acetic acid, acetone, cylophexylamine, dibasic ester, diethylamine or diethylketone.

18. The method according to claim 1 further comprising taking the processed coatings off of the sheets.

19. The method according to claim 1 further comprising using a jogger to give a stack a required uniformity and registration.

20. The method according to claim 1, further comprising using a means for collating to organise to organize a stack.

21. The method according to claim 1 further comprising using electrical heating elements that are part of the sheets, or conduction of heat by means of conductive plates in or on the sheets to heat the stack.

22. The method according to claim 21 further comprising bringing the conductive plates into contact with heating blocks so that edges of the plates touch the blocks and the heat is conducted into the stack.

23. The method according to claim 1 further comprising applying pressure to the stack during heating.

24. The method according to claim 1 further comprising placing the the coatings on top of and bonding the coatings to the sheets that contain conductive plates.

25. An apparatus for making a part comprising:
means for executing a slicing program to control a manufacturing means that makes coatings that are cross sectional slices of the part;
means for organizing coatings, sheets and conductive plates to form a stack made of consecutive arrangements of plates, sheets and coatings;
means for heating the stack to process the coatings;
means for cooling the stack; and,
means for removing coatings from the stack.

26. An apparatus according to claim 25 further comprising a means for recycling heat taken out of the stack during cooling.

27. An apparatus according to claim 26 further comprising a heat transfer means for recycling the heat.

28. An apparatus according to claim 27 further comprising a heat pump means for recycling the heat.

29. An apparatus according to claim 28 further comprising means for using the recycled heat to increase the amount of power used in processing stacks.

30. An apparatus, as claimed in claim 25, wherein the means for cooling further comprises means for annealing the processed coatings.

31. An apparatus according to claim 30 further comprising means for separating a cooled stack to leave the coatings on the sheets.

32. An apparatus according to claim 31 further comprising:
means for organizing new coatings on sheets with cooled coatings on sheets and conductive plates so that a stack made of consecutive arrangements of plate, sheet and coating is formed;
means for heating the stack to process the new coatings and to bond the new coatings previously processed and cooled;
means for cooling the stack; and
means for removing coatings from the stack.

33. An apparatus according to claim 32 wherein the conductive plate are selected from the group consisting of graphite, aluminium, copper, stainless steel, nicrome, steel, tungsten, molybdenum, tantalum, carbon, gold, platinum, boron and combinations thereof.

34. An apparatus according to claim 33 wherein the means for removing coatings further comprises means for releasing sections from the coatings that are not to be permanently coated.

35. An apparatus according to claim 34 wherein the means for releasing employs dissolving or catalysing.

36. An apparatus, as claimed in claim 34, wherein the means for releasing employs manual release peeling, shot blasting or thermal degradation.

37. An apparatus according to claim 36 further comprising means for taking the processed coatings off of the sheets.

38. An apparatus claims 37 further comprising jogger means to give the stack the required uniformity and registration.

39. An apparatus according to claims 38 a further comprising means for collating to organize a stack.

40. An apparatus according to claim 39 wherein the means for heating further comprises electrical heating elements or conductive plates that are parts of the sheets.

41. An apparatus according to claim 40 further comprising a heating block means in contact with edges of the conductive plates to conduct heat into the stack.

42. An apparatus according to claim 41 further comprising means for applying pressure to the stack during heating.
